(19) United States
(12) Patent Application Publication
(10) Pub. No.: US 2015/0287020 A1
(43) Pub. Date: Oct. 8, 2015

(54) INFERRING CARDHOLDER FROM KNOWN LOCATIONS

(71) Applicant: MasterCard International Incorporated, Purchase, NY (US)

(72) Inventors: Kenny Unser, Fairfield, CT (US); Jean-Pierre Gerard, Croton-On-Hudson, NY (US); Kent Olof Niklas Berntsson, Rye, NY (US)

(21) Appl. No.: 14/457,831

(22) Filed: Aug. 12, 2014

Related U.S. Application Data
(60) Provisional application No. 61/974,670, filed on Apr. 3, 2014.

(51) Int. Cl. G06Q 20/32; G06Q 20/40

(52) U.S. Cl. CPC G06Q 20/3224; G06Q 20/4016

(57) ABSTRACT

A method includes receiving a first data set and accessing a second data set. The first data set includes location and time profiles. The second data set includes transaction profiles. The first and second data sets are analyzed to propose matches of location and time profiles with transaction profiles. A respective score is assigned to each proposed match. In the analysis and assignment of scores, a first percentage is assigned to each location and time profile relative to each transaction profile. The first percentage equals a percentage of data elements in the location and time profile that is represented in the respective transaction profile. For some of the transaction profiles, a second percentage is assigned. The second percentage equals the percentage of transactions in the transaction profile that is represented in a proposed matching location and time profile.

### CROSS REFERENCE TO RELATED APPLICATION

This application claims the benefit of U.S. Provisional Patent Application No. 61/974,670 filed on Apr. 3, 2014, the contents of which are hereby incorporated by reference for all purposes.

### BACKGROUND

There may be situations in which law enforcement authorities may lack the name of an individual suspected of wrongdoing, but may have some information concerning where the individual was located at particular times in the past. It would be desirable in such situations if the authorities could gain leads as to the individual's identity.

In a situation that is different from the above in some ways but analogous in others, commercial enterprises may have information about some or all of their customers concerning where the customers were located at certain times. The commercial enterprises may find it desirable to learn more information concerning those customers in order to enhance or focus the marketing efforts of the commercial enterprise.

The present inventors have now recognized that payment card transaction data may be analyzed relative to a location profile of a known or unknown individual. Such an analysis may lead to possible or likely identities for an unknown individual by comparing the individual's known or suspected past whereabouts with the geographic and temporal patterns of purchase transactions with particular payment account cards. Such an analysis may also produce information about merchants' customers that may augment what the merchants already know about their customers.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a functional block diagram that illustrates a system provided in accordance with aspects of the present invention.

FIG. 2 shows a system architecture within which some embodiments may be implemented.

FIG. 3 is a block diagram that illustrates a computer system that may provide functionality within the system of FIGS. 1 and 2.

FIG. 4 is a flow chart that illustrates a process that may be performed in accordance with aspects of the present disclosure.

FIG. 5 is a flow chart that illustrates details of some embodiments of the process of FIG. 4.

### DETAILED DESCRIPTION

Embodiments of the present invention relate to systems and methods for analyzing transaction data and data indicative of individuals' locations at various times. More particularly, embodiments relate to systems and methods for comparing location and time profiles for individuals with transaction profiles for individual holders of payment card accounts, in order to potentially match transaction profiles with location and time profiles.

A number of terms are used herein. For example, the term “location and time profile” refers to a set of data in which locations are paired with points in time to indicate where an individual (known or unknown) was located at those points in time.

The term “transaction profile” refers to a set of data that reflects payment card account transactions consummated by use of a particular payment card account.

The terms “de-identified data” or “de-identified data sets” are used to refer to data or data sets which have been processed or filtered to remove any personally identifiable information (“PII”). The de-identification may be performed in any of a number of ways, although in some embodiments, the de-identified data may be generated using a filtering process which removes PII and associates a de-identified unique identifier (or de-identified unique “ID”) with each record (as will be described further below).

The term “non-identified data” is used to refer to data that has never been associated with PII for an individual to which it pertains. One example of non-identified data may be data indicative of the whereabouts or possible whereabouts of an unknown individual at certain points in time in the past.

The term “payment card network” or “payment network” is used to refer to a payment network or payment system such as the systems operated by MasterCard International Incorporated (which is the assignee hereof), or other networks which process payment transactions on behalf of a number of merchants, issuers and cardholders. The terms “payment card network data” or “network transaction data” are used to refer to transaction data associated with payment transactions that have been processed over a payment network. For example, network transaction data may include a number of data records associated with individual payment transactions that have been processed over a payment card network. In some embodiments, network transaction data may include information identifying a payment device or account, transaction date and time, transaction amount, and information identifying a merchant or merchant category, and a location at which the transaction occurred. Additional transaction details may be available in some embodiments.

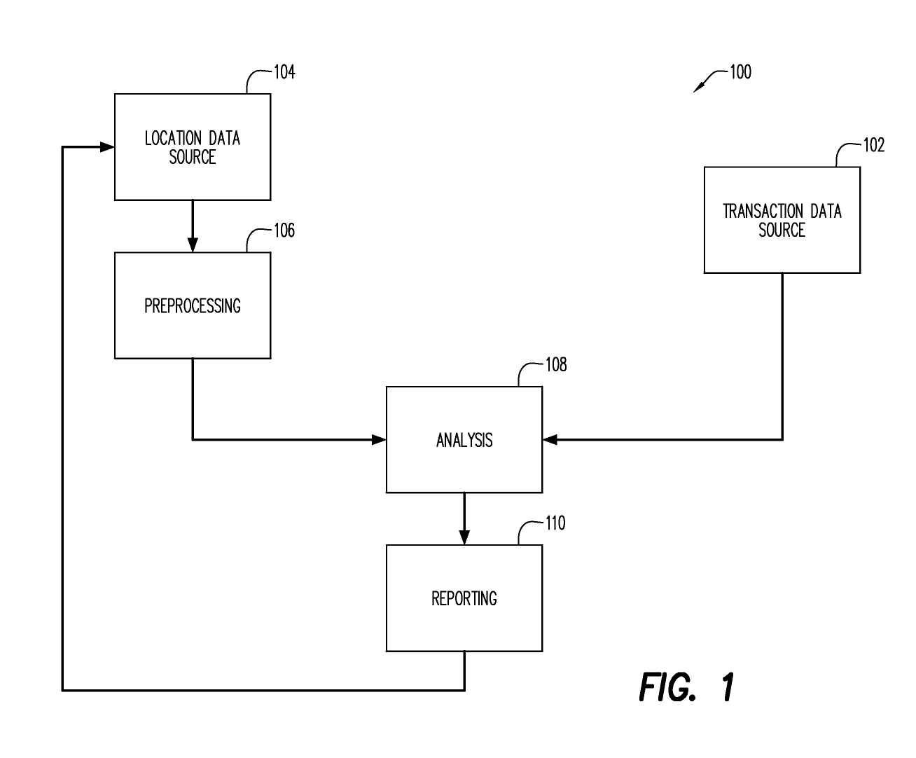

FIG. 1 is a functional block diagram that illustrates a data analysis system 100 provided in accordance with aspects of the present invention.

The data analysis system 100 may include a source 102 of network transaction data produced in and stored by a conventional payment network (not shown) in connection with payment card account transactions handled by the payment network. The transaction data may be in the form of transaction profiles, or may be processed so as to be in that form. Each transaction profile may represent transactions performed using a particular payment card account.

Also shown in FIG. 1 is a source 104 of location data. The location data may include location and time profiles for one or more known or unknown individuals. For each such individual, the respective location and time profile may represent movements of the individual from one location to another over time.

Block 106 in FIG. 1 represents a processing block in which the location and time profile data from source 104 may be preprocessed to be placed in a format suitable for subsequent analysis/comparison with the transaction data.

Block 108 in FIG. 1 represents a processing block that may perform an analysis for matching one or more of the location and time profiles with one or more of the transaction profiles. Analysis block 108 may be in data communication with the transaction data source 102 and with the preprocessing block 106.

Also shown in FIG. 1 is a reporting block 110. The reporting block may be in data communication with the analysis block 108 and may operate to report the results of the profile analysis/matching back to the location data source 104.

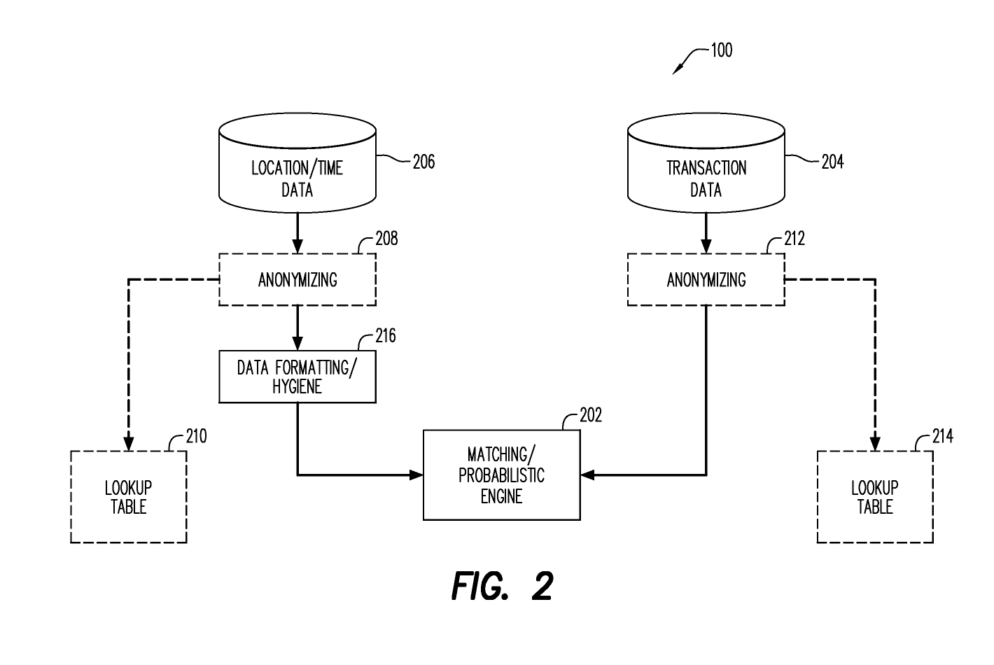

Features of some embodiments of the present invention will now be described with reference to FIG. 2, where block diagram portions of the data analysis system 100 are shown. The data analysis system 100 may be operated by or on behalf of an entity that provides data analysis services. For example, in some embodiments, the data analysis system 100 may be operated by or on behalf of a payment network or association (e.g., such as MasterCard International Incorporated).

The data analysis system 100 includes a matching/probabilistic engine 202 to generate reports and analyses associated with data matched by the matching/probabilistic engine 202. In some embodiments, the matching/probabilistic engine 202 receives or analyzes data from several data sources, including transaction data 204 (which may come from the transaction data source 102 shown in FIG. 1) and location/time data 206 (FIG. 2; such data may come from the location data source 104 shown in FIG. 1). In some embodiments, the data to be analyzed by the matching/probabilistic engine 202 may be pre-processed. For example, at block 208, the location/time data 206 may be anonymized by removing any PII therefrom. Instead of the PII, the anonymized location/time data may instead include a de-identified unique identifier code that may be generated in any convenient manner by the anonymizing block 206. Consequently, the location/time data as provided to the matching/probabilistic engine 202 may be de-identified data. The anonymizing block 208 may generate a lookup table 210 to link the de-identified unique identifier for each location and time profile to the corresponding PII that was associated with the profile before it was anonymized In some embodiments, the anonymization of the location/time data may occur before it is delivered to the entity that operates the matching/probabilistic engine 202.

Furthermore, at block 212, the transaction data 204 may be anonymized by removing any PII therefrom. For example, the anonymizing block 212 may substitute a de-identified unique identifier code for the PII that was associated with each transaction profile be anonymization. In some embodiments the PII may be a PAN (primary account number) for the corresponding payment card account and the de-identified unique identifier code may be generated by applying a function to the PAN. The function may be, for example, a hash function or the like. The anonymizing block 212 may generate a lookup table 214 to link the de-identified unique identifier for each transaction profile to the PAN or other PII originally associated with the transaction profile before it was anonymized. Consequently, in some embodiments, the transaction data as provided to the matching/probabilistic engine 202 may be de-identified data.

At block 216, the location/time data may be pre-processed to place it in a correct format for the matching/probabilistic engine 202 and/or to remove unnecessary data elements.

In some embodiments, the matching/probabilistic engine 202 may operate to perform an inferred match analysis to assess an inferred linkage between the location/time data and the transaction data. The inferred match analysis may be based in part on the portion of the transaction data that indicates the dates/times/locations of the transactions.

As used herein, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. In addition, entire modules, or portions thereof, may also be implemented in programmable hardware devices such as field programmable gate arrays, programmable array logic, programmable logic devices or the like or as hardwired integrated circuits.

In some embodiments, the modules of FIG. 1 and FIG. 2 are software modules operating on one or more computers. In some embodiments, control of the input, execution and outputs of some or all of the modules may be via a user interface module (not shown) which includes a thin or thick client application in addition to, or instead of a web browser.

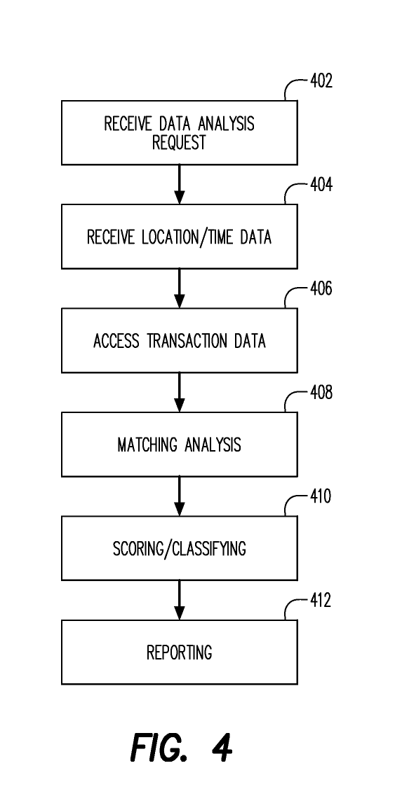

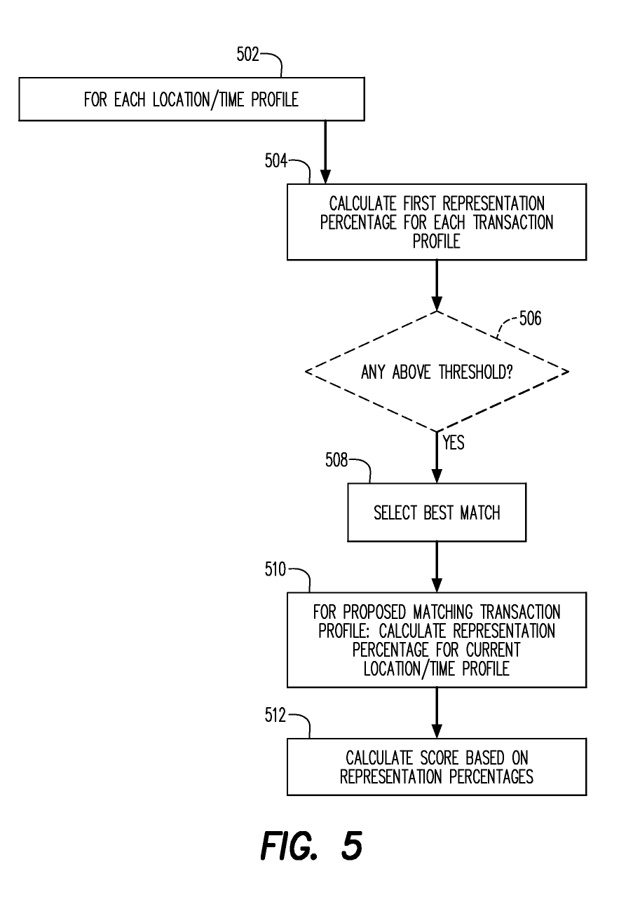

The matching/probabilistic engine 202 may be operated to establish a linkage between the location/time data and the transaction data. In some embodiments, the linkage may be a probability score or other scoring measure that indicates, as between a location and time profile and a transaction profile how likely it is that the two profiles correspond to the same individual. Examples of suitable analytic techniques will be discussed below in connection with FIGS. 4 and 5. The matching/probabilistic engine 202 may operate to match the location and time profiles with the transaction profiles with some level of probability. The level of probability may also be referred to as “the pattern match”. The pattern match could range from 0 to 1 (i.e., from 0% to 100%). An alternative manner of scoring and indicating the likelihood of matching may also be employed. In some embodiments, the match probability could be represented by a classification label (e.g., “close”, “moderate”, “loose”, or “no match”) instead of or in addition to a numerical or percentage score.

Location and time profiles and transaction profiles may be linked in a many-to-many fashion and given some level of probability and/or a score and/or a classification label for each pattern match (e.g., 100 location and time profiles and 100 transaction profiles could result in 10,000 probabilities or the like).

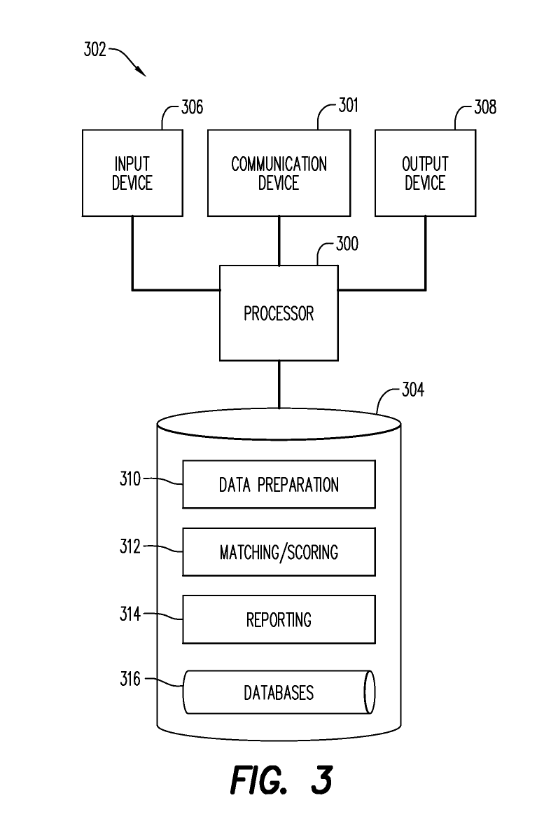

FIG. 3 is a block diagram representation of a computer system 302 that may be operated in accordance with aspects of the invention to provide at least some of the functionality described herein. This computer system may hereinafter be referred to as a “profile matching computer 302”.

The profile matching computer 302 may be conventional in its hardware aspects but may be controlled by software to cause it to function as described herein. In some embodiments, functionality disclosed herein may be distributed among two or more computers having a hardware architecture similar to that described below.

The profile matching computer 302 may include a computer processor 300 operatively coupled to a communication device 301, a storage device 304, an input device 306 and an output device 308.

The computer processor 300 may be constituted by one or more conventional processors. Processor 300 operates to execute processor-executable steps, contained in program instructions described below, so as to control the profile matching computer 302 to provide desired functionality.

Communication device 301 may be used to facilitate communication with, for example, other devices (such as sources of location/time data and transaction data). For example, communication device 301 may comprise one or more communication ports (not separately shown), to allow the profile matching computer 302 to communicate with other computers and other devices.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of the profile matching computer 302, executed by the processor 300 to cause the profile matching computer 302 to function as described herein.

The programs may include one or more conventional operating systems (not shown) that control the processor 300 so as to manage and coordinate activities and sharing of resources in the profile matching computer 302, and to serve as a host for application programs (described below) that run on the profile matching computer 302.

The programs stored in the storage device 304 may also include, in some embodiments, a data preparation program 310 that controls the processor 300 to enable the profile matching computer 302 to perform operations on data received by the profile matching computer 302 to place the data in an appropriate condition for subsequent analysis and profile matching. For example, and as will be described in more detail below, location and/or geographic information may be translated into a standard format to facilitate detection of possible matches between location/time profiles and transaction profiles.

Another program that may be stored in the storage device 304 is profile matching and scoring application program 312 that controls the processor 300 to enable the profile matching computer 302 to perform analysis with respect to the profile data, to detect potential matches between location/time profiles and transaction profiles and to calculate scores that may be applied to the potential matches to indicate the degree of confidence that the potential matches are correct.

In addition, the storage device 304 may store a reporting application program 314 that controls the processor 300 to enable the profile matching computer 302 to report results of the matching and scoring analysis performed by the matching/scoring application program 312.

The storage device 304 may also store, and the profile matching computer 302 may also execute, other programs, which are not shown. For example, such programs may include, e. g., communication software, device drivers, etc.

The storage device 304 may also store one or more databases 316 required for operation of the profile matching computer 302. Such databases, for example, may store at least temporarily the location/time profiles and the transaction profiles to be analyzed and matched by the profile matching computer 302.

FIG. 4 is a flow chart that illustrates a process that may be performed in accordance with aspects of the present disclosure. At least some portions of the process of FIG. 4 may be performed by the profile matching computer 302 under the control of the software programs referred to above.

At 402 in FIG. 4, the profile matching computer 302 may receive input indicative of a request for data analysis. This request may, for example, come from law enforcement authorities who have location and time/date information about a suspected wrongdoer (e.g., times and locations of crimes committed by the individual) but who do not know the individual's identity. The request from the law enforcement authorities may be to identify one or more payment cardholders whose patterns of payment card transactions may place them at the known or suspected past locations and the known or suspected times of the suspect's presence there.

As another example, the request may come from a commercial enterprise such as a merchant or service company. The commercial enterprise may have location and time information about their customers, but may wish to increase their understanding of their customer base by learning about the customers' spending behavior as tied in with the customers' movements from place to place.

It is also possible that the commercial enterprise may be a social network that has “check-in” information about its users, and would like to learn about the user's spending habits to improve targeting of advertising to the social network's users. In some embodiments, the location and time location may be obtained based on interactions with customer's mobile phones and/or may be supplied by a mobile network operator (MNO).

For convenience of reference, the entity requesting the analysis, whether law-enforcement related or commercial or otherwise, will hereinafter be referred to as the “client”.

In addition to the foregoing, other types of requests from clients are also possible.

At 404 in FIG. 4, the profile matching computer 302 may receive from the client a data set of time and location profile data. If the client is a law enforcement entity, the data received at 404 may consist of only a single profile—for example, a list of locations of crimes believed committed by a sole, unknown suspect, and the times at which each crime was submitted. In other cases, e.g., for a commercial client, the time/location data may consist of many profiles, corresponding to a large number of customers and/or users of the client's services. In some embodiments, the location data may be presented in a predetermined format so that the respective locations in the location/time pairs are defined in a manner that is most suitable for the matching analysis to be performed by the profile matching computer 302. For example, in some embodiments, the location may be indicated simply by a postal code (e.g., a U.S. Postal Service zip code). Other types of geographical codes may also be employed. In other embodiments or use cases, the location may be indicated as a metropolitan area. For this purpose, either MSAs (metropolitan statistical areas) or DMAs (designated market areas) may be used. In some embodiments, the location may be defined with a granularity in the range of a few meters via detailed longitude/latitude coordinates. Politically defined geographical locations, such as counties or states/provinces, may also be used.

The time information in the location/time data pairs may also be presented with varying degrees of granularity. In some embodiments the indicated time is a date, such that the granularity of the time information is daily. Other granularities are also possible, such as weekly, monthly or hourly.

At 406 in FIG. 4, the profile matching computer 302 may access a data set of transaction profile data. For example, the operator of the profile matching computer 302 may be a payment network or an affiliate of a payment network, and may have access directly or indirectly to at least a subset of network transaction data generated and stored by the payment network. In other embodiments, the profile matching computer 302 may receive the transaction profile data from a related or unrelated party.

In some embodiments, for the purpose of the intended profile matching analysis, each profile may be formatted as a collection of location/time data pairs (with a unique identifier appended to each profile), with each such pair indicative of the time and location at which the payment card account in question was used for a respective transaction. Both the granularity of the location information and of the time information in the transaction profile data set may match the granularities of the data set received from the client at 404.

In some embodiments, the data as received from the client, and/or the transaction data, may not be in an optimal format for the intended matching analysis. In such situations, the profile matching computer 302 may reformat the data from the client and/or the transaction data to facilitate the matching analysis.

At 408, the profile matching computer 302 performs an analysis to detect matches or potential matches between the location/time profiles in the client-supplied data set with the profiles in the transaction data set. It is contemplated to use one or more of a considerable number of matching techniques, including one or more measurements of correlation, linear or logistic regression, variable reduction analysis, distance statistics, clustering analysis, and/or decision tree analysis. Other matching analysis techniques may also or alternatively be used. In one particular embodiment, as described below in connection with FIG. 5, a statistical analysis using percentages of matched data pairs may be employed.

In some embodiments, test data sets may be generated using volunteers to travel from place to place and engage in payment card transactions, and the suitability and/or effectiveness of matching analysis techniques may be evaluated by applying the techniques to the test data sets.

A location data indicator in a client-supplied data pair need not necessarily be identical to a location data indicator in a transaction data pair for matching or partial or tentative matching to be declared or detected. For example, a distance threshold, or more than one threshold, may be applied such that location indicators within the threshold distance(s) relative to each other may be deemed to be matching or partially matching. For example, and assuming that both the client data set location indicators and the transaction data set location indicators are in the form of highly granular longitude/latitude information, in some embodiments locations within five miles of each other could be deemed matching; i.e., five miles could be the threshold distance for declaring a match in this embodiment. Other threshold distances may alternatively be employed. In some embodiments, the threshold distances may be adjusted by population density in the relevant area, such that two locations in an urban area must be closer to each other to be deemed “matching” as compared to locations in a rural area.

At 410, the profile matching computer 302 may generate or apply scores to the proposed matches of client-provided profiles with transaction data profiles (unless the matching analysis technique(s) employed at 408 inherently provided confidence/probability scoring). In addition or alternatively at 410, the profile matching computer 302 may classify the profile matches. For example, as noted above, thresholds may be applied to classify the profile matches as “close”, “moderate”, “loose” or “no match”. Other sets of classifications may alternatively be used in other embodiments.

At 412, the profile matching computer 302 may report the result of steps 408 and 410 to an operator and/or to the client.

FIG. 5 is a flow chart that illustrates details of some embodiments of the process of FIG. 4. In particular, FIG. 5 shows certain ways in which blocks 408 and 410 of FIG. 4 may be implemented.

Referring to FIG. 5, block 502 indicates that the ensuing process steps may be performed sequentially for each location/time profile in the data set supplied from the client.

At 504, for the current location/time profile, each transaction data profile is considered in turn. For the transaction data profile under consideration, a percentage is calculated as the percentage of location/time data pairs in the current location/time profile that are deemed to have at least one matching transaction in the transaction data profile under consideration (i.e., that are deemed to be represented in the transaction data profile under consideration).

In some embodiments, a decision block 506 may follow block 504. At decision block 506 a threshold may be applied to the percentages calculated at 504, and only for percentages in excess of the threshold will the corresponding transaction data profile be deemed a match or potential match for the current location/time profile.

Block 508 may follow decision block 506 if one or more positive determinations are made at decision block 506 (or block 508 may directly follow block 504 if decision block 506 is not present in the process of FIG. 5). At 508, the profile matching computer 302 selects the transaction data profile that best matches (i.e., that has the highest percentage score) for the current location/time profile. Or alternatively, a certain number (greater than one) of “best” matches may be selected at 508. (It should be noted that block 508 may not be reached for the current location/time profile if decision block 506 is included in the process and none of the transaction data profiles produces a large enough percentage score to reach the threshold.)

For each proposed matching transaction data profile selected at 508, block 510 may be performed. At block 510, for the proposed matching transaction data profile in question, a percentage is calculated as the percentage of transactions in the transaction data profile that are deemed to have at least one matching location/time data pair in the current location/time profile (i.e., that are deemed to be represented in the current location/time profile). The percentage calculated at 504 for the proposed match of the current location/time profile and the transaction profile selected at 508 and considered at 510 may be referred to as the “first direction representation percentage”. The percentage calculated at 510 may be referred to as the “second direction representation percentage”.

Block 512 may follow block 510. At block 512, the profile matching computer 302 may calculate a score for each proposed match of the current location/time profile with a transaction data profile selected at 508. For example, the score at block 512 may be calculated as a formula that has the first direction representation percentage and the second direction representation percentage as inputs. Such a formula may, for example, be a linear combination of the first direction representation percentage and the second direction representation percentage, with respective weighting factors being applied to the two percentages. Other approaches are also possible, including nonlinear combinations of the two percentages. Other types of scoring may also be performed at 512, including scoring that does not utilize one or both of the first direction representation percentage and the second direction representation percentage.

In the process illustrated in FIG. 5, representation percentages are calculated first to find a percentage of representation of client data profiles in transaction data profiles, and thereafter a representation percentage or percentages are calculated in the other direction (i.e., to determine what percentage of transactions in the transaction data profile are represented in a proposed matching client data profile). However, in other embodiments, representation percentages may first be calculated to find a percentage of representation of transaction data profiles in one or more client data profiles (i.e., calculations to determine what percentage of transactions in a respective transaction data profile are represented in each of one or more client data profiles), and then after that, representation percentages may be calculated in the other direction (i.e., to determine what percentage of location/time pairs in a respective client data profile are represented in a proposed matching transaction data profile or profiles).

An inferred match analysis as described in connection with FIGS. 4 and/or 5 may be useful in providing law enforcement authorities with potential identities to match with a suspect whose past travel pattern is at least partially known. In the case where the client is a law enforcement authority the operator of the profile matching computer 302 may appropriately provide PII for a matching transaction data profile to assist the client in its criminal investigation.

In cases where the client is a commercial enterprise, it may be more likely that the operator of the profile matching computer 302 may not provide PII to the client. However, the matches or potential matches developed with the processes of FIGS. 4 and/or 5 may allow for a wide range of potential insights to be provided to the client in these cases as well. For example, the client may be informed as to how its customers' spending habits relate to their travel habits. This information may be provided on an individual basis or with respect to various categories or groupings of the client's customers. These may aid the client in producing more effectively targeted advertising or promotional initiatives for their customers. Other types of information that may be made available to clients as a result of the above-described inferred matching of travel profiles to transaction profiles may include propensity models, customer profiles, demographic information, customer list enhancement, best customer modeling, lifetime customer value modeling, past travel habits, client's market share, customer prospecting, etc.

Although a number of “assumptions” are provided herein, the assumptions are provided as illustrative but not limiting examples of one particular embodiment—those skilled in the art will appreciate that other embodiments may have different rules or assumptions.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The flow charts and descriptions thereof herein should not be understood to prescribe a fixed order of performing the method steps described therein. Rather the method steps may be performed in any order that is practicable.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A computerized method comprising:
receiving a first data set, the first data set including a plurality of location and time profiles, each of said profiles corresponding to a respective individual represented in the first data set and representing movements by said respective individual;
receiving a second data set, the second data set including a plurality of transaction profiles, each of said transaction profiles corresponding to a respective individual represented in the second data set, each of the transaction profiles reflecting payment card account transactions by the respective individual who corresponds to each said transaction profile;
analyzing said first and second data sets to propose matches of said location and time profiles with said transaction profiles; and
assigning a respective score to each of said proposed matches, said respective scores indicating a degree of confidence as to whether a respective proposed match is correct;
said analyzing and assigning scores including, for each of said location and time profiles, determining first percentages for each said location and time profile, each of said first percentages being a percentage of data elements in each said location and time profile that are represented in a respective one of said transaction profiles; and
said analyzing and assigning scores including, for each of at least some of said transaction profiles, determining a second percentage for each said transaction profile, said second percentage being a percentage of transactions in each said transaction profile that are represented in a proposed matching one of said location and time profiles.

2. The method of claim 1, wherein said assigning scores includes applying respective weighting factors to said first and second percentages determined for a respective match of a one of said location and time profiles with a one of said transaction profiles.

3. The method of claim 1, wherein each location and time profile includes geographic data expressed as one or more of: (a) latitude plus longitude data; (b) name of a city or town; (c) postal code; (d) name of a state or province; (e) custom geographic designations; and (f) other indications of geographic location.

4. The method of claim 1, wherein one or both of the sets of data consist of de-identified or non-identified data.

5. A computerized method comprising:
receiving a first data set, the first data set including a plurality of location and time profiles, each of said profiles corresponding to a respective individual represented in the first data set and representing movements by said respective individual;
receiving a second data set, the second data set including a plurality of transaction profiles, each of said transaction profiles corresponding to a respective individual represented in the second data set, each of the transaction profiles reflecting payment card account transactions by the respective individual who corresponds to each said transaction profile;
analyzing said first and second data sets to propose matches of said transaction profiles with said location and time profiles; and
assigning a respective score to each of said proposed matches, said respective scores indicating a degree of confidence as to whether a respective proposed match is correct;
said analyzing and assigning scores including, for each of said transaction profiles, determining first percentages for each said transaction profile, each of said first percentages being a percentage of transactions in each said location and time profile that are represented in a respective one of said location and time profiles; and
said analyzing and assigning scores including, for each of at least some of said location and time profiles, determining a second percentage for each said location and time profile, said second percentage being a percentage of data elements in each said location and time profile that are represented in a proposed matching one of said transaction profiles.

6. The method of claim 5, wherein said assigning scores includes applying respective weighting factors to said first and second percentages determined for a respective match of a one of said location and time profiles with a one of said transaction profiles.

7. The method of claim 5, wherein each location and time profile includes geographic data expressed as one or more of: (a) latitude plus longitude data; (b) name of a city or town; (c) postal code; (d) name of a state or province; (e) custom geographic designations; and (f) other indications of geographic location.

8. The method of claim 5, wherein one or both of the sets of data consist of de-identified or non-identified data.
